(19) United States
(12) Patent Application Publication
(10) Pub. No.: US 2011/0181909 A1
(43) Pub. Date: Jul. 28, 2011

(54) Image forming apparatus, image forming method, and program

(75) Inventor: Akihiro Kakoi, Kanagawa (JP)

(73) Assignee: Ricoh Company, Limited, Tokyo (JP)

(21) Appl. No.: 12/929,277

(22) Filed: Jan. 12, 2011

(30) Foreign Application Priority Data
Jan. 27, 2010 (JP) 2010-015898

(51) Int. Cl. G06F 15/00

(52) U.S. Cl. 358/1.15

(57) ABSTRACT

An image forming apparatus includes: a range designation receiving unit that receives designation of a range of an image to read; a read control unit that performs control to read an image of a predetermined region in addition to the designated range; a detecting unit that detects a code where information to determine a process for the range of the image is embedded, from the read image of the predetermined region; and an image output unit that outputs the read range of the image.

### CROSS-REFERENCE TO RELATED APPLICATIONS

The present application claims priority to and incorporates by reference the entire contents of Japanese Patent Application No. 2010-015898 filed in Japan on Jan. 27, 2010.

### BACKGROUND OF THE INVENTION

1. Field of the Invention

The present invention generally relates to an image forming apparatus, an image forming method, and a program.

2. Description of the Related Art

In the related art, an image forming apparatus that has a function (hereinafter, referred to as code detecting function) of detecting a code including a two-dimensional code such as a quick response (QR) code or a one-dimensional code such as a barcode is known. The image forming apparatus executes a suppressing function of preventing a duplication of an image such as copying or e-mail sending on the basis of information embedded in the detected code. In general, the image forming apparatus has an image editing function. In this case, the image editing function that is accompanied with an image processing function such as a coping function or a scanner function, is to edit an image by restricting or changing a range to be processed. For example, the image editing function specifies designation of a read range.

The code is generally printed on any of four corners of a document to prevent the code from being missed in reading due to the direction difference of paper set to a scanner. The code detecting function is implemented by a method of reading the four corners of the document by the scanner and detecting the code.

For example, in order to securely execute the suppressing function, a method that detects the QR code on the document, confirms whether a printer has output authority, on the basis of information embedded in the QR code, and prohibits printing when the printer does not have the output authority is disclosed (for example, Japanese Patent Application Laid-open No. 2008-288847).

However, according to a technology disclosed in Japanese Patent Application Laid-open No. 2008-288847, when the code detecting function and the image editing function are configured to coexist, the four corners of the document may not be read and the code may be missed in reading. As a result, the code detecting function may not be effective. For example, the code detecting function may not be performed in the case where a read range is designated in platen printing and the code exists out of the read range, the case where a part of an image is designated to be erased and the code exists in the erased image, and the case where only a single surface of a both-sided document in which the code does not exist is designated to be copied.

According to the present invention, the code detecting function and the existing image editing function can be configured to coexist.

### SUMMARY OF THE INVENTION

It is an object of the present invention to at least partially solve the problems in the conventional technology.

According to an aspect of the present invention, there is provided an image forming apparatus including: a range designation receiving unit that receives designation of a range of an image to read; a read control unit that performs control to read an image of a predetermined region in addition to the designated range; a detecting unit that detects a code where information to determine a process for the range of the image is embedded, from the read image of the predetermined region; and an image output unit that outputs the read range of the image.

According to another aspect of the present invention, there is provided a method of forming an image for an image forming apparatus that includes a range designation receiving unit; a read control unit; a detecting unit; and an image output unit, the method including: receiving a designation of a range in an image to read by the range designation receiving unit; controlling to read an image of a predetermined region in addition to the designated range by the read control unit; detecting a code where information to determine processing for the image of the range is embedded, from the read image of the predetermined region by the detecting unit; and outputting the read image of the range by the image output unit.

According to still another aspect of the present invention, there is provided a computer program product comprising a non-transitory computer-usable medium having computer-readable program codes embodied in the medium for an image forming apparatus that includes a range designation receiving unit; a read control unit; a detecting unit; and an image output unit, the program codes when executed causing a computer to execute: receiving a designation of a range in an image to read by the range designation receiving unit; controlling to read an image of a predetermined region in addition to the designated range by the read control unit; detecting a code where information to determine processing for the image of the range is embedded, from the read image of the predetermined region by the detecting unit; and outputting the read image of the range by the image output unit.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a block diagram showing a hardware configuration of an image forming apparatus according to a first embodiment of the present invention;

FIG. 2 is a block diagram showing the software configuration of a CPU 101 according to the first embodiment;

FIG. 3 is a diagram showing an example of a barcode arrangement position;

FIG. 4 is a diagram showing an example of a read range that is designated by a user;

FIG. 5 is a flowchart illustrating a flow of a code detecting process that is executed by the image forming apparatus according to the first embodiment;

FIG. 6 is a diagram showing an example of a read range of a document image and a code region;

FIG. 7 is a diagram showing an example of a document image that is acquired by a read control unit 208 and a read range that is included in the document image;

FIG. 8 is a block diagram showing a software configuration of a CPU 101 according to a second embodiment;

FIG. 9 is a flowchart illustrating a flow of a code detecting process that is executed by an image forming apparatus according to the second embodiment;

FIG. 10 is a diagram showing an example of a code region and a read range;

FIG. 11 is a diagram showing an example of images that are acquired by a read control unit 208;

FIG. 12 is a flowchart illustrating a sequence of a reading process that is executed by the read control unit 208;

FIG. 13 is a diagram showing a positional relationship between a document and a traveling object before reading of a document starts;

FIG. 14 is a diagram showing a movement direction of the traveling object in document reading;

FIG. 15 is a diagram showing a distance of the read range and the code region;

FIG. 16 is a diagram showing the movement speed of the traveling object in the case where a continuous scanning region is a whole surface of the document;

FIG. 17 is a diagram showing an example of the continuous scanning region;

FIG. 18 is a diagram showing the movement speed of the traveling object in the case where the continuous scanning region is a second image and a third image;

FIG. 19 is a diagram showing the second image and the third example that is the continuous scanning region;

FIG. 20 is a diagram showing the movement speed of the traveling object in the case where the continuous scanning region is a first image and a fourth image;

FIG. 21 is a diagram showing coordinates of a rear end region;

FIG. 22 is a diagram showing the movement speed of the traveling object in the case where the continuous scanning region is the first image, the third image, and the fourth image;

FIG. 23 is a diagram showing the first image, the third image, and the fourth image that are the continuous scanning region;

FIG. 24 is a block diagram showing a software configuration of a CPU 101 according to a third embodiment;

FIG. 25 is a flowchart illustrating a flow of a code detecting process that is executed by an image forming apparatus according to the third embodiment;

FIG. 26 is a block diagram showing a software configuration of a CPU 101 according to a fourth embodiment;

FIG. 27 is a flowchart illustrating a flow of a code detecting process that is executed by an image forming apparatus according to the fourth embodiment;

FIG. 28 is a diagram showing an example of an erasure range;

FIG. 29 is a diagram showing an example of an image that is obtained after the erasure range is erased;

FIG. 30 is a diagram showing an example of an image that is read by a read control unit 208;

FIG. 31 is a diagram showing an example of a code region;

FIG. 32 is a diagram showing an example of an image that is obtained after the erasure range is erased;

FIG. 33 is a diagram showing an example of a both-sided document where an arbitrary rectangular shape in the document is designated as an erasure range;

FIG. 34 is a diagram showing a positional relationship between an erasure range and a code region; and

FIG. 35 is a diagram showing an example of a document where the center of a document is designated as an erasure range.

### DETAILED DESCRIPTION OF THE PREFERRED EMBODIMENTS

Hereinafter, embodiments of an image forming apparatus, an image forming method, and a program according to the present invention will be described in detail with reference to the accompanying drawings. In the embodiments described below, the case where the image forming apparatus according to the present invention is applied to multi-function peripherals (MFP) having at least two functions of a coping function, a printer function, a scanner function, and a facsimile function is exemplified. However, the present invention is not limited thereto and may be applied to any image forming apparatus, such as a copy machine, a printer, a facsimile device, and a scanner device.

### First Embodiment

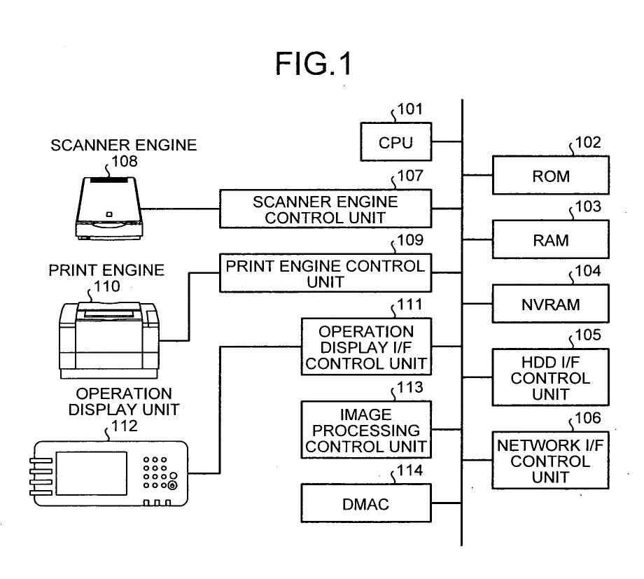

FIG. 1 is a block diagram showing the hardware configuration of an image forming apparatus according to a first embodiment of the present invention. As shown in FIG. 1, the image forming apparatus includes a CPU 101, a read only memory (ROM) 102, a random access memory (RAM) 103, a non-volatile memory (NVRAM) 104, a hard disk drive interface (HDD I/F) control unit 105, a network interface (I/F) control unit 106, a scanner engine control unit 107, a print engine control unit 109, an operation display I/F control unit 111, an image processing control unit 113, and a direct memory access controller (DMAC) 114.

The CPU 101 executes a program and causes to operate the various control units. A specific function of the CPU 101 will be described below.

The ROM 102, the RAM 103, and the NVRAM 104 store a variety of data. The HDD I/F control unit 105 is connected to an HDD that stores an image, the program, and the data. The network I/F control unit 106 controls a network I/F, such as Ethernet (registered trademark).

The scanner engine control unit 107 is connected to a scanner engine including an automatic document reading device (not shown in the drawings) or a platen reading mechanism (not shown in the drawings), and transmits a control command for reading a document, reads an image input from a scanner, and writes the image in the RAM 104.

The print engine control unit 109 is connected to a print engine 110 including an image forming unit conveying paper and forming an image on the paper, and transmits a print command, reads image data to be printed from the RAM 104, and transmits the image data to the print engine 110.

The operation display I/F control unit 111 receives a button input from a user, or is connected to an operation display unit 112 including a display device (liquid crystal display (LCD) or touch panel) and receives an operation input. The operation display I/F control unit 111 transmits received operation contents to the CPU 101 and displays the operation contents on the operation display unit 112 by the CPU 101.

The image processing control unit 113 executes image processing (magnification, mask, trimming, color adjustment, and rotation) on the image data stored in the RAM 104, according to an instruction from the CPU 101, and stores an image of the processing result in the RAM 104.

The DMAC 114 copies data of a read range, which is stored in the RAM 104, into another place of the RAM 104, according to an instruction from the CPU 101. In this case, the read range is a range of the document that is read as an object of an output such as a copy or distribution, by the read control unit 208. In addition, the read range is a range that is designated from the operation display unit 112 by the user.

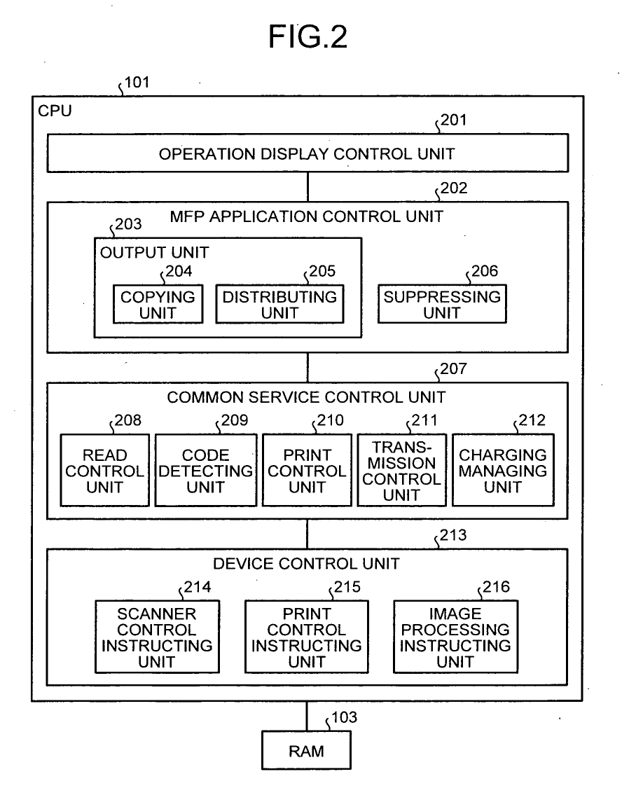

FIG. 2 is a block diagram showing an example of the software configuration of the CPU 101. As shown in FIG. 2, the CPU 101 includes an operation display control unit 201, an MFP application control unit 202, a common service control unit 207, and a device control unit 213 as main components, and is connected to the RAM 103.

The operation display control unit 201 causes the operation display I/F control unit 111 to display an image on the operation display unit 112. The operation display control unit 201 acquires operation contents (hereinafter, referred to as user operation contents) input from the user through a key operation on the operation display unit 112 or a screen contact, and transmits the operation contents to the individual units of the MFP application control unit 202. The operation display control unit 201 displays an output prohibition of an image, according to an instruction from a suppressing unit 206.

First, the MFP application control unit 202 includes an output unit 203 and the suppressing unit 206. The output unit 203 includes a copying unit 204 and a distributing unit 205 and outputs the read image by the individual units.

The copying unit 204 converts the user operation contents, which are received from the operation display control unit 201, into the copy execution conditions, transmits an instruction such as read or print to the common service control unit 207, and outputs the copied document.

The distributing unit 205 converts the user operation contents, which are received from the operation display control unit 201, into the distribution execution conditions and transmits the converted contents to the common service control unit 207. The distributing unit 205 acquires an image from the common service control unit 207 and distributes the acquired image to an apparatus corresponding to the designation destination.

When the suppressing unit 206 receives a code detected by a code detecting unit 209 from the common service control unit 207, the suppressing unit 206 suppresses print or transmission of an image that is instructed in the user operation contents. Specifically, the suppressing unit 206 stops a printing job, transmits an instruction to display a print prohibition to the operation display control unit 201 or sends an e-mail of an output prohibition to a host computer through a transmission control unit 211 of the common service control unit 207.

Next, the common service control unit 207 includes a read control unit 208, the code detecting unit 209, a print control unit 210, the transmission control unit 211, and a charging managing unit 212 as main components.

The read control unit 208 secures a memory needed to print and transmit an image, according to an instruction from the MFP application control unit 202, and transmits various instructions to the scanner engine control unit 107, the print engine control unit 109, and the network I/F control unit 106 through the device control unit 213.

The code detecting unit 209 detects a code from an image read according to a read instruction from the read control unit 208. In this case, the code is a code where information to control predetermined processing such as the output prohibition is embedded. For example, the code is a barcode. In this embodiment, an example in which the code is the barcode is explained. Alternatively, the present invention is not limited thereto and the code may be another code such as a QR code where other information is embedded.

The transmission control unit 211 controls transmission and reception of a variety of information with the operation display control unit 201, the MFP application control unit 202, the common service control unit 207, and the device control unit 213. The transmission control unit 211 controls communication with other device such as a host computer connected to the image forming apparatus.

The charging managing unit 212 counts the number of images that are read by the read control unit 208 or the number of images that are printed by the print control unit 210 and manages charging that is related to an image output. In order to count up the number of images counted by a counter, the charging managing unit 212 read a value of the counter that is stored in a counter region of the NVRAM 104, updates (adds) the value, and stores the value.

Next, the device control unit 213 includes a scanner control instructing unit 214, a print control instructing unit 215, and an image processing instructing unit 216.

The scanner control instructing unit 214 transmits a read instruction of the document to the scanner engine control unit 107, according to an instruction from the common service control unit 207.

The print control instructing unit 215 transmits a print instruction to the print engine control unit 109, according to an instruction from the common service control unit 207.

The image processing instructing unit 216 transmits an image processing instruction to the image processing control unit 113, according to an instruction from the common service control unit 207.

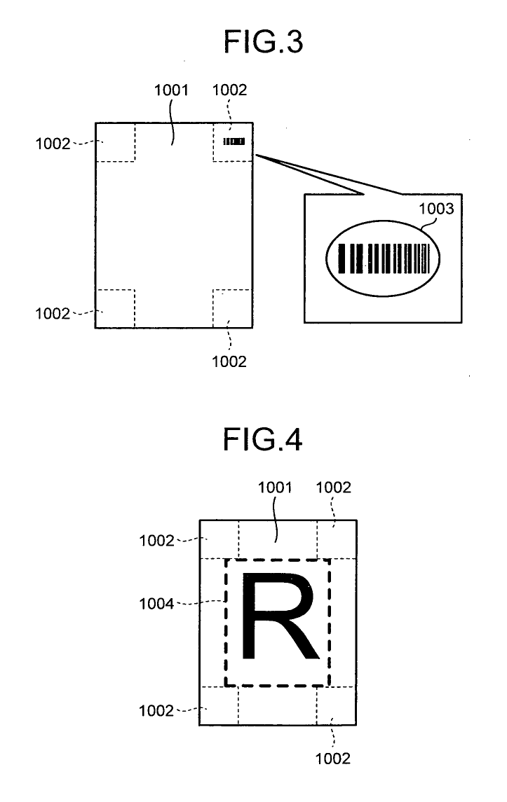

Next, the barcode arrangement position will be described. FIG. 3 shows an example of the barcode arrangement position. As shown in FIG. 3, regions (hereinafter, referred to as code regions) 1002 where the barcode is arranged are determined in four corners of a plane (surface or back surface) of paper of document paper 1001. The barcode that are recognized by the image forming apparatus may be arranged in any of the four code regions 1002 that are determined in one plane of paper. In FIG. 3, a barcode 1003 is printed on the region 1002 of an upper right end.

FIG. 4 shows an example of a read range that is designated by the user. As shown in FIG. 4, the operation display control unit 201 receives the designation of a range of the document 1001 near the center as a read range 1004. The read control unit 208 transmits an instruction to scan the read range 1004 to the scanner control instructing unit 214, according to an instruction received by the operation display control unit 201. The scanner control instructing unit 214 transmits an instruction to scan the read range 1004 to a scanner engine 108. The scanner engine 108 scans the read range 1004 according to an instruction from the scanner control instructing unit 214.

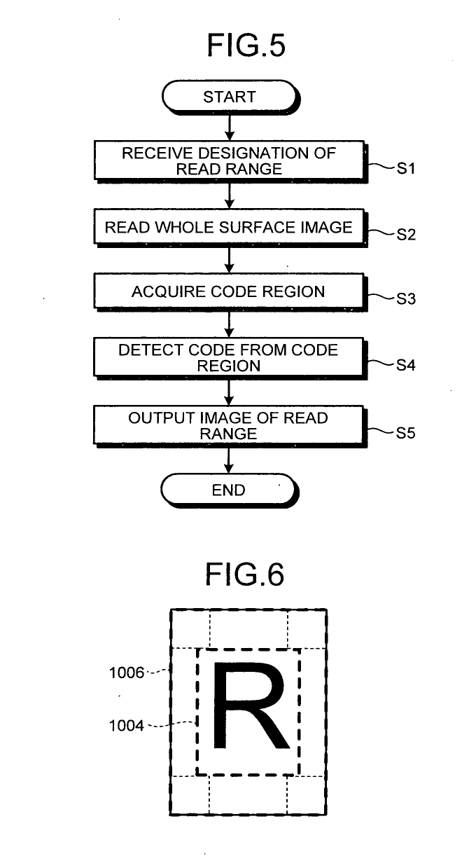

Next, a sequence of a code detecting process that is executed by the image forming apparatus according to the first embodiment having the above configuration will be described. FIG. 5 is a flowchart illustrating a flow of the code detecting process that is executed by the image forming apparatus according to the first embodiment.

The operation display control unit 201 receives the designation of the read range from the operation display unit 112 input by the user (Step S1). FIG. 6 shows an example of a read range of a document image and a code region. As shown in FIG. 6, the read range 1004 is the designated read range that is received by the operation display control unit 201. A code region 1006 is a code region that is acquired by the read control unit 208.

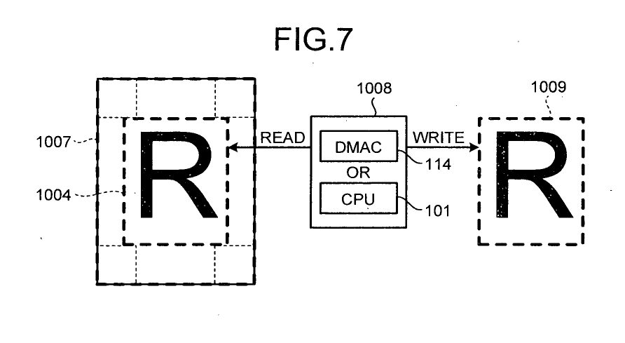

Referring back to FIG. 5, the read control unit 208 instructs the scanner control instructing unit 214 to read the code region 1006 corresponding to the whole surface image of the document (Step S2). The read control unit 208 acquires the code region 1006 (Step S3). Specifically, the read control unit 208 transmits a read instruction of the code region 1006 to the scanner control instructing unit 214 and acquires an image of the code region 1006 from the scanner engine 108 through a scanner instruction from the scanner control instructing unit 214. FIG. 7 shows an example of a document image that is acquired by the read control unit 208 and a read range that is included in the document image. As shown in FIG. 7, the read control unit 208 acquires a code region 1007 and the read range 1004.

The read control unit 208 transmits the acquired code region 1007 to the code detecting unit 209. The code detecting unit 209 detects a barcode from the received code region 1007 (Step S4). For example, the code detecting unit 209 searches the four corners of the code region 1007 and detects the barcode.

The read control unit 208 acquires the read range 1004 from the whole surface image 1007 of the document, by using a memory coping function 1008 provided by the DMAC 114 (refer to FIG. 1) or the CPU 101 (refer to FIG. 1). The read control unit 208 transmits the acquired read range 1004 as a read range 1009 to the output unit 203.

The output unit 203 outputs the read range 1009 that is received from the read control unit 208 (Step S5). For example, the output unit 203 copies the read range 1009 by a copying unit 251 or transmits the read range 1009 by a distributing unit 252.

As such, according to this embodiment, even when the read range is designated, the code detecting unit 209 detects the code from the code region. Therefore, the code detecting function and the existing image editing function can be configured to coexist.

### Second Embodiment

In the first embodiment, when the read range is designated, the whole surface image of the document is acquired and the barcode is detected from the whole surface image. In this embodiment, when the read range is designated, the read range and the image of the predetermined code region are acquired and the barcode is detected from the code region.

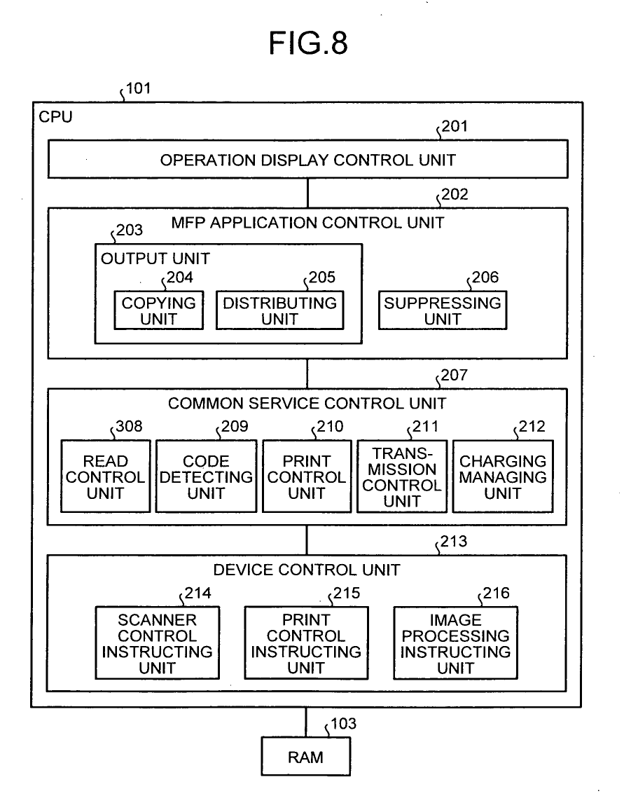

The hardware configuration of the image forming apparatus according to this embodiment is the same as that of the first embodiment. FIG. 8 is a block diagram showing an example of the software configuration of the CPU 101. As shown in FIG. 8, the CPU 101 includes the operation display control unit 201, an MFP application control unit 202, a common service control unit 207, and a device control unit 213, and is connected to the RAM 103. The functions and configurations of the individual units of the software configuration of the CPU 101 other than a read control unit 308 are the same as those of the first embodiment.

The RAM 103 previously stores the coordinates of the code regions in the document or numerical values to specify the code regions. For example, the RAM 103 stores numerical values of regions of four directions apart from paper ends by 5 cm as the respective numerical values of the code regions.

The read control unit 308 acquires the coordinates of the code region in the document or the numerical value to specify the code region, from the RAM 103, and acquires the code region. The read control unit 308 reads the acquired code region and the read range received from the operation display control unit 201.

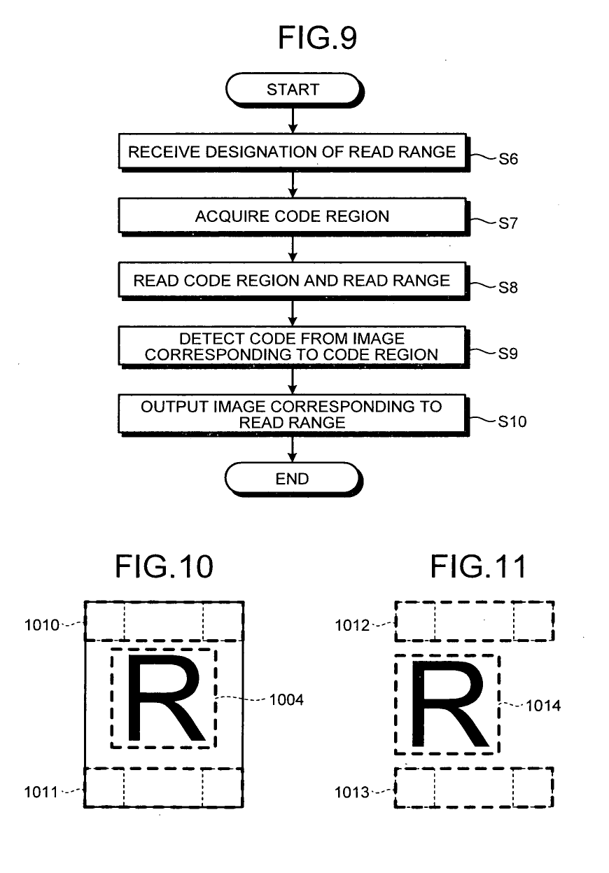

Next, a sequence of a code detecting process that is executed by the image forming apparatus according to the second embodiment having the above configuration will be described. FIG. 9 is a flowchart illustrating a flow of the code detecting process that is executed by the image forming apparatus according to the second embodiment.

The operation display control unit 201 receives the designation of the read range input from the operation display unit 112 by the user (Step S6). The read control unit 308 acquires the code region from the RAM 103 (Step S7). FIG. 10 shows an example of the code region and the read range. As shown in FIG. 10, the read control unit 308 acquires a region (hereinafter, referred to as front end region) 1010 being a front end with respect to a sub-scanning direction and a region (hereinafter, referred to as rear end region) 1011 being a rear end with respect to the sub-scanning direction, which are stored in the RAM 103, as the code regions. The read control unit 308 acquires the read range 1004 from the operation display control unit 201.

The read control unit 308 acquires an image corresponding to the read range and an image corresponding to the code region (Step S8). FIG. 11 shows an example of images that are acquired by the read control unit 308. As shown in FIG. 11, the read control unit 308 reads the front end region 1010 and the rear end region 1011 acquired from the RAM 103 and the read range 1004 acquired from the operation display control unit 201 through the scanner control instructing unit 214. The read control unit 308 then acquires an image 1012 corresponding to the front end region 1010, an image 1013 corresponding to the rear end region 1011, and an image 1014 corresponding to the read range 1004.

The code detecting unit 209 detects the barcode from the images (image 1012 and image 1014) corresponding to the code regions (Step S9). The output unit 203 outputs the image (image 1014) corresponding to the read range (Step S10). For example, the output unit 203 copies the read range 1009 by the copying unit 204 or transmits the read range 1009 by the distributing unit 205. Since the image (image 1009) corresponding to the read range is read separately from the images (image 1012 and image 1014) that correspond to the code regions, a copying operation does not need to be executed by the DMAC 114 or the CPU 101. Therefore, a quick output is enabled.

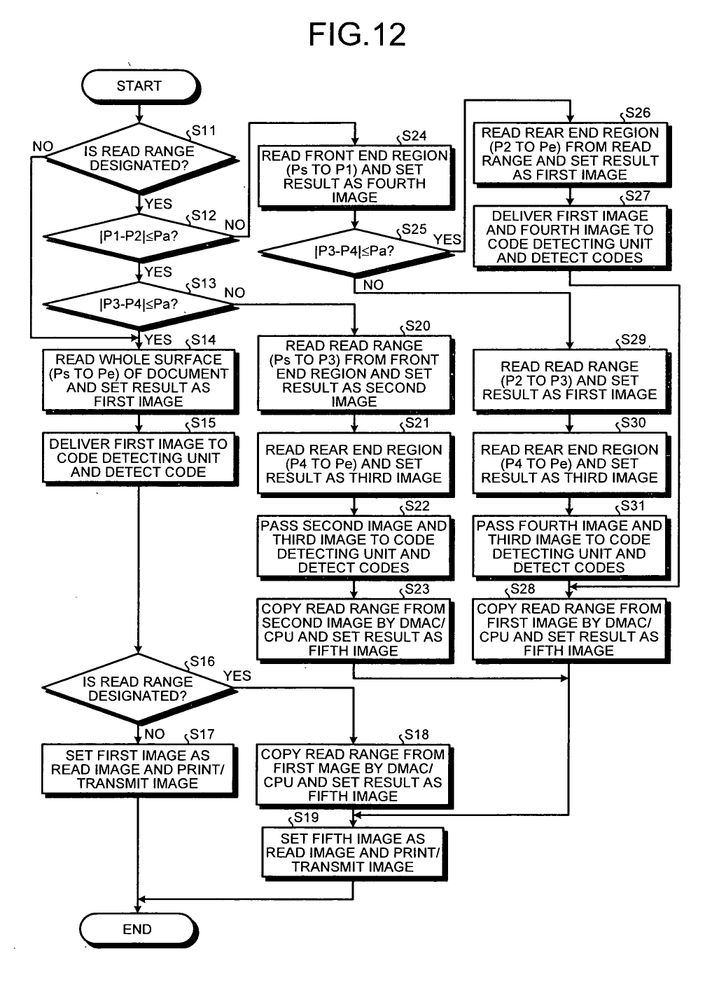

Next, a reading process that is executed by the read control unit 308 in Step S8 will be described in detail. FIG. 12 is a flowchart illustrating a sequence of the reading process that is executed by the read control unit 308.

The read control unit 308 confirms whether the designation of the read range is received by the operation display control unit 201 (Step S11). When it is confirmed that the designation of the read range is received (Yes in Step S11), the read control unit 308 measures the distance of the read range and the code region in the sub-scanning direction and determines a continuous scanning region. The continuous scanning region is a region where a traveling object is continuously scanned on the document. On the other hand, the read control unit 308 proceeds to Step S14 when it is confirmed that the designation of the read range is not received (No in Step S11).

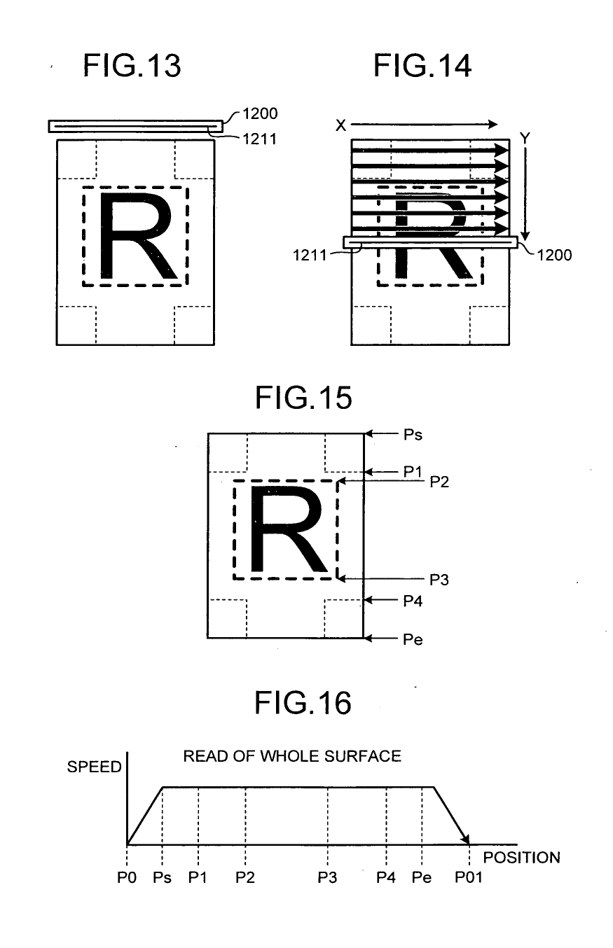

In this case, first, a movement direction of the traveling object will be described. FIG. 13 shows a positional relationship between a document and a traveling object before reading of a document starts. As shown in FIG. 13, a traveling object 1200 includes a scanning unit 1211 that reads the document and is positioned at an upper end of the document before the document read start. FIG. 14 shows a movement direction of the traveling object in document reading. As shown in FIG. 14, the read control unit 308 causes the scanning unit 1211 to move in an arrow direction of X indicating a main scanning direction on the document while moving the traveling object 1200 in an arrow direction of Y indicating the sub-scanning direction on the document, thereby reading an image.

Next, the distance of the read range and the code region will be described. FIG. 15 shows the distance of the read range and the code region. In this case, the distance is the distance of each region on the document in the sub-scanning direction. As shown in FIG. 15, the coordinates Ps to P1 show the distance of the front end region. The coordinates P2 to P3 show the distance of the read range. The coordinates P4 to Pe show the distance of the rear end region.

Next, a method of determining the continuous scanning region of the traveling object 1200 will be described. The read control unit 308 determines the continuous scanning region based on whether each of the distance from a terminating end of the front end region to a front end of the read range and the distance from the rear end of the read range to the front end of the rear end region is equal to or less than a threshold value Pa. When each of the distance (coordinates P1 to P2) from the terminating end of the front end region to the front end of the read range, and the distance (coordinates P3 to P4) from the rear end of the read range to the front end of the rear end region is equal to or less than the threshold value Pa, the read control unit 308 determines the continuous scanning region as the whole surface of the document. Thereby, since the read range can be scanned without decreasing the movement speed of the traveling object 1200, the read speed increases. On the other hand, when each distance is more than the threshold value Pa, the read control unit 308 determines the continuous scanning region as three regions of the front end region, the read range, and the rear end region. When the distance not exceeding the threshold value Pa is included, the read control unit 308 determines the two regions before and after the distance not exceeding the threshold value Pa as one continuous scanning region and determines the remaining one region as another continuous scanning region.

In Step S12, the read control unit 308 confirms whether the distance from the terminating end of the front end region to the front end of the read range satisfies |P1−P2|≦Pa (Step S12). That is, the read control unit 308 confirms whether the Y coordinate difference of the coordinates P2 and the coordinates P1 is equal to or less than the threshold value Pa. When it is determined that |P1−P2|≦Pa is satisfied (Yes in Step S12), the read control unit 308 confirms whether |P3−P4|≦Pa is satisfied (Step S13). That is, the read control unit 308 confirms whether the Y coordinate difference of the coordinates P3 and the coordinates P4 is equal to or less than the threshold value Pa. When it is determined that the Y coordinate difference of the coordinates P3 and the coordinates P4 is equal to or less than the threshold value Pa (Yes in Step S13) or when it is confirmed that the designation of the read range is not received in Step S1 (No in Step S11), the read control unit 308 determines the continuous scanning region as the whole surface (coordinates Ps to coordinates Pe) of the document. The read control unit 308 reads the whole surface (coordinates Ps to coordinates Pe) of the document and stores an image obtained as the read result as a first image (Step S14).

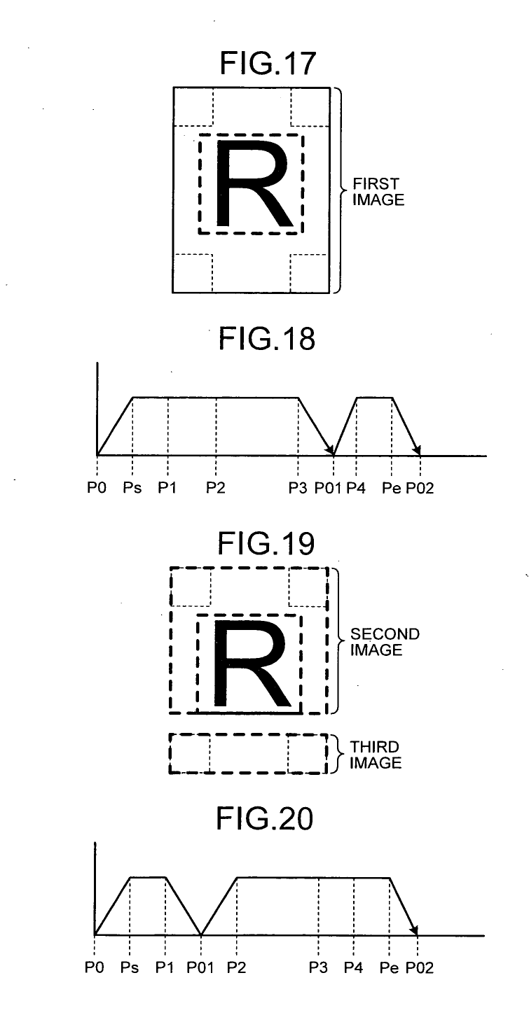

FIG. 16 shows the movement speed of the traveling object in the case where the continuous scanning region is the whole surface of the document. As shown in FIG. 16, the read control unit 308 causes the traveling object 1200 to move continuously at one time from the front end region corresponding to the front end of the document to the rear end region corresponding to the rear end of the document. The coordinates P0 to Ps show the distance where the traveling object 1200 is accelerated. The coordinates Pe to P01 show the distance where the traveling object 1200 is decelerated until the traveling object is stopped, after read ends. The individual coordinates Ps to Pe show the coordinates of the individual regions of the front end region, the read range, and the rear end region on the document. FIG. 17 shows an example of the continuous scanning region. As shown in FIG. 17, the read control unit 308 stores the whole surface of the read document as the first image. As such, when determining the continuous scanning region as the whole surface of the document, the read control unit 308 causes the traveling object 1200 to move without deceleration during the movement. Therefore, the read speed can be improved as compared with the case where scanning is divided for each region.

The read control unit 308 passes the first image to the code detecting unit 209 and the code detecting unit 209 detects a code of the first image (Step S15). The read control unit 308 confirms whether the designation of the read range is received (Step S16). When it is confirmed that the designation of the read range is not received (No in Step S16), the read control unit 308 passes the first image as a read image to the print control unit 210 and the transmission control unit 211. Furthermore, the print control unit 210 prints the first image and the transmission control unit 211 transmits the first image (Step S17).

On the other hand, when it is confirmed that the designation of the read range is received (Yes in Step S16), the read control unit 308 copies the first image by using the DMAC 114 or the CPU 101 and stores the copied image as a fifth image (Step S18). The read control unit 308 passes the fifth image as a read image to the print control unit 210 and the transmission control unit 211, and the print control unit 210 prints the fifth image and the transmission control unit 211 transmits the fifth image (Step S19).

In Step S13, the read control unit 308 confirms whether |P3−P4|≦Pa is satisfied (Step S13). When it is determined that |P3−P4|≦Pa is not satisfied (No in Step S13), the read control unit 308 confirms whether the difference of the coordinates P3 and P4 is equal to or less than the threshold value Pa. When it is determined that the difference of the coordinates P3 and the coordinates P4 is more than the threshold value Pa (No in Step S13), the read control unit 308 reads the read range (from the coordinates Ps to the coordinates P3) from the front end region and stores an image obtained as the read result as the second image (Step S20).

The read control unit 308 reads the rear end region (from the coordinates P4 to the coordinates Pe) and stores an image obtained as the read result as the third image (Step S21). The read control unit 308 passes the second image and the third image to the code detecting unit 209, and the code detecting unit 209 detects a code from the second image and the third image (Step S22). The read control unit 308 copies the read range from the second image by the DMAC 114 or the CPU 101 and stores the copied image as the fifth image (Step S23). The read control unit 308 passes the fifth image as a read image to the print control unit 210 and the transmission control unit 211, and the print control unit 210 prints the fifth image and the transmission control unit 211 transmits the fifth image (Step 19).

FIG. 18 shows the movement speed of the traveling object in the case where a continuous scanning region is the second image and the third image. As shown in FIG. 18, the read control unit 308 causes the traveling object 1200 to move individually in two scanning regions, the regions being a region from the front end region to the read range and the rear end region. The coordinates P0 to Ps and the coordinates P01 to P4 show the distance where the traveling object 1200 is accelerated. The coordinates P3 to P01 and the coordinates Pe to P02 show the distance where the traveling object 1200 is decelerated until the traveling object is stopped, after the read ends. The coordinates Ps to P3 show the coordinates of the front end region and the read range and the coordinates P4 to Pe show the coordinates of the rear end region. FIG. 19 shows the second image and the third example that are the continuous scanning region. As shown in FIG. 19, the read control unit 308 stores the region from the read front end region to the read range as the second image, and stores the rear end region as the third image.

Next, in Step S2, when it is determined that the distance from the terminating end of the front end region to the front end of the read range does not satisfy |P1−P2|≦Pa (No in Step S12), the read control unit 308 reads the front end region (from the coordinates Ps to the coordinates P1) and stores an image obtained as the read result as the fourth image (Step S24).

The read control unit 308 confirms whether |P3−P4|≦Pa is satisfied (Step S25). When it is determined that P3−P4|≦Pa is satisfied (Yes in Step S25), the read control unit 308 reads the rear end region (from the coordinates P2 to the coordinates Pe) from the read range, and stores an image obtained as the read result as the first image (Step S26). The read control unit 308 passes the first image and the fourth image to the code detecting unit 209, and the code detecting unit 209 detects a code from the first image and the fourth image (Step S27). The read control unit 308 copies the read range from the first image by the DMAC 114 or the CPU 101 and stores the copied image as the fifth image (Step S28). The read control unit 308 passes the fifth image as a read image to the print control unit 210 and the transmission control unit 211. The print control unit 210 prints the fifth image and the transmission control unit 211 transmits the fifth image (Step 19).

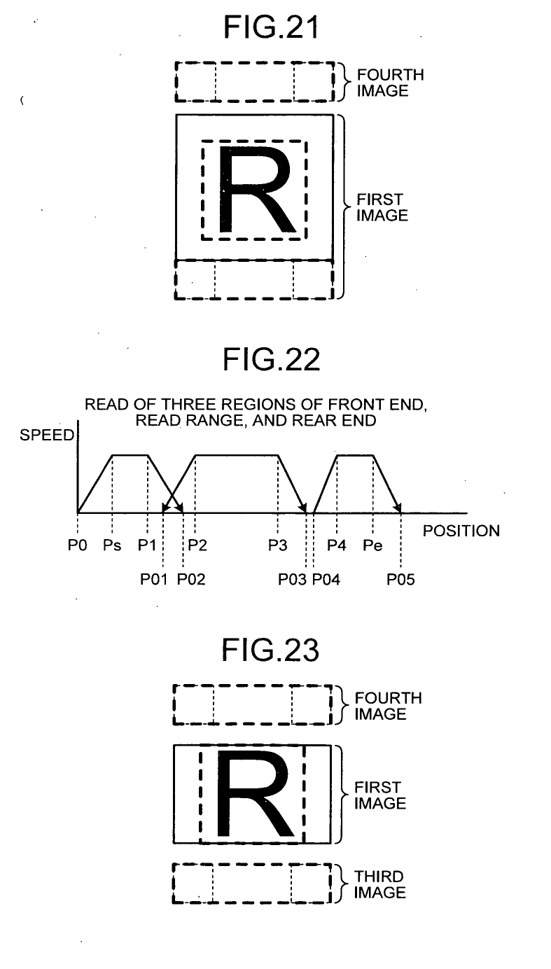

FIG. 20 shows the movement speed of the traveling object in the case where the continuous scanning region is the first image and the fourth image. As shown in FIG. 20, the read control unit 308 causes the traveling object 1200 to move individually in two scanning regions, the two scanning regions being the front end region and a region from the read range to the rear end region. The coordinates P0 to Ps and the coordinates P01 to P2 show the distances where the traveling object 1200 is accelerated. The coordinates P1 to P01 and the coordinates Pe to P02 show the distances where the traveling object 1200 is decelerated until the traveling object is stopped after the read ends. The coordinates Ps to P1 show the coordinates of the front end region and the coordinates P2 to Pe show the coordinates of the read range and the rear end region. FIG. 21 shows the first image and the fourth image that are the continuous scanning region. As shown in FIG. 21, the read control unit 308 stores the read front end region as the fourth image and stores the rear end region as the first image. As such, if the continuous scanning region is divided based on the distance between the regions, the read speed can be improved according to each region and read is enabled in a state where the memory use amount is suppressed.

Next, in Step S25, the read control unit 308 confirms whether |P3−P4|≦Pa is satisfied (Step S25). When it is determined that |P3−P4|≦Pa is not satisfied (Step S25: No), the read control unit 308 reads the read range (from the coordinates P2 to the coordinates P3) and stores an image obtained as the read result as the first image (Step S29). The read control unit 308 reads the rear end region (from the coordinates P4 to the coordinates Pe) and stores an image obtained as the read result as the third image (Step S30). The read control unit 308 passes the third image and the fourth image to the code detecting unit 209 and the code detecting unit 209 detects a code from the third image and the fourth image (Step S31). The read control unit 308 copies the read range from the first image by the DMAC 114 or the CPU 101 and stores the copied image as the fifth image (Step S18). The read control unit 308 passes the fifth image as a read image to the print control unit 210 and the transmission control unit 211, and the print control unit 210 prints the fifth image and the transmission control unit 211 transmits the fifth image (Step 19).

FIG. 22 shows the movement speed of the traveling object in the case where the continuous scanning region is the first image, the third image, and the fourth image. As shown in FIG. 22, the read control unit 308 causes the traveling object 1200 to move individually in three regions of the front end region, the region including the read range, and the rear end region. The coordinates P0 to Ps, the coordinates P01 to P2, and the coordinates P04 to P4 show the distances where the traveling object 1200 is accelerated. The coordinates P1 to P02, the coordinates P3 to P03, and the coordinates Pe to P05 show the distances where the traveling object 1200 is decelerated until the traveling object is stopped after the read ends. The coordinates Ps to P1 show the coordinates of the front end region, the coordinates P2 to P3 show the coordinates of the read range, and the coordinates P4 to Pe show the coordinates of the rear end region. FIG. 23 shows the first image, the third image, and the fourth image that are the continuous scanning region. As shown in FIG. 23, the read control unit 308 stores the read front end region as the fourth image, stores the region including the read range as the first image, and stores the rear end region as the third image. As such, when the continuous scanning region is divided into the three regions, read is enabled in a state where the memory use amount is suppressed, as compared with the whole surface of the document is read continuously at one time.

As such, according to this embodiment, the code detecting function that can coexist with the existing image editing function can be realized.

As such, according to this embodiment, since the code detecting unit 209 detects the barcode from the images that correspond to the predetermined code regions, the detection speed can be increased.

As such, according to this embodiment, since the continuous scanning region is determined according to the positional relationship between the code region and the read range, the read speed can be improved and read is enabled in a state where the memory use amount is suppressed.

### Third Embodiment

In the second embodiment, the case where the read control unit receives the designation of the read range on the front surface of the document is described. In the third embodiment, the case where the read control unit receives the designation of the read range on any one of the front surface and the back surface of a both-sided document will be described.

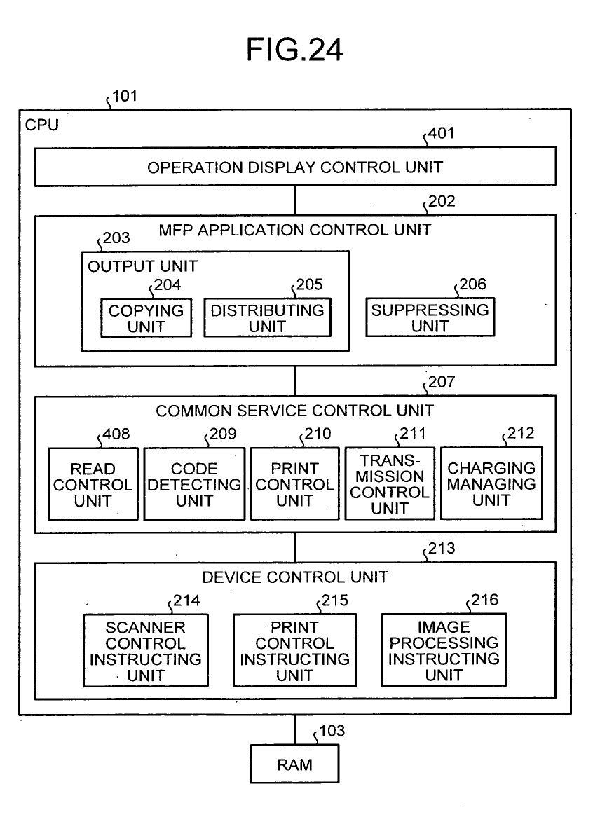

The hardware configuration of the image forming apparatus according to this embodiment is the same as that of the first embodiment. FIG. 24 is a block diagram showing the software configuration of the CPU 101 according to the third embodiment. As shown in FIG. 24, the CPU 101 includes an operation display control unit 401, an MFP application control unit 202, a common service control unit 207, and a device control unit 213 as main components, and is connected to the RAM 103. The functions and configurations of the individual units of the software configuration of the CPU 101 other than a read control unit 408 are the same as those of the second embodiment.

The operation display control unit 401 receives the designation of the read range. Specifically, the operation display control unit 401 receives the designation of any one of the front surface and the back surface of the document as the read range.

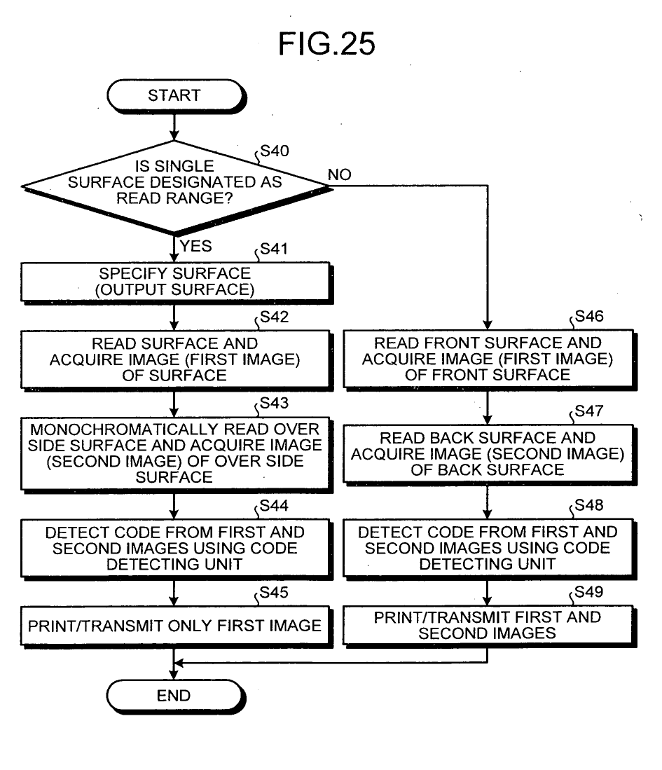

Next, a sequence of a code detecting process that is executed by the image forming apparatus according to the third embodiment having the above configuration will be described. FIG. 25 is a flowchart illustrating a flow of the code detecting process that is executed by the image forming apparatus according to the third embodiment.

The read control unit 408 confirms whether the designation of the single surface of the both-sided document as the read range is received by the operation display control unit 401 (Step S40). The read control unit 408 specifies the designated single surface as the surface (output surface) (Step S41) when it is confirmed that the designation of the single surface is received (Yes in Step S40). The read control unit 408 reads the specified surface and acquires the read surface as the first image (Step S42).

The read control unit 408 monochromatically reads the over side surface and acquires an image of the read over side surface as the second image (Step S43). In this case, the over side surface is a surface that is not designated as the read range. The read control unit 408 passes the first image and the second image to the code detecting unit 209 and the code detecting unit 209 detects a code from the first image and the second image (Step S44).

The read control unit 408 passes the first image as the read image to the print control unit 210 and the transmission control unit 211, and the print control unit 210 prints the first image and the transmission control unit 211 transmits the first image (Step S45).

In Step S40, when it is confirmed that the designation of the single surface as the read range is not received by the operation display control unit 401 (No in Step S40), the read control unit 408 reads the front surface and acquires the read image as the first image (Step S46). Next, the read control unit 408 reads the back surface and acquires the read back surface as the second image (Step S47). The read control unit 408 passes the first image and the second image to the code detecting unit 209 and the code detecting unit 209 detects a code from the first image and the second image (Step S48).

The read control unit 408 passes the first image and the second image as the read images to the print control unit 210 and the transmission control unit 211, and the print control unit 210 prints the first image and the second image and the transmission control unit 211 transmits the first image and the second image (Step S49).

As described above, according to this embodiment, even when the designation of the single surface of the both-sided document as the read range is received, both surfaces are read to detect the code. Therefore, the code that exists on the surface different from the designated surface can be securely detected.

Furthermore, according to this embodiment, even when the images of both surfaces of the both-sided document are read to detect the code, if the single surface is designated as the read range, the surface that is not the read range is monochromatically read. Therefore, the memory use amount in the reading process can be suppressed.

### Fourth Embodiment

In the second embodiment, the case where the designation of the read range is received is described. In this embodiment, the case where the designation of an erasure range is received will be described.

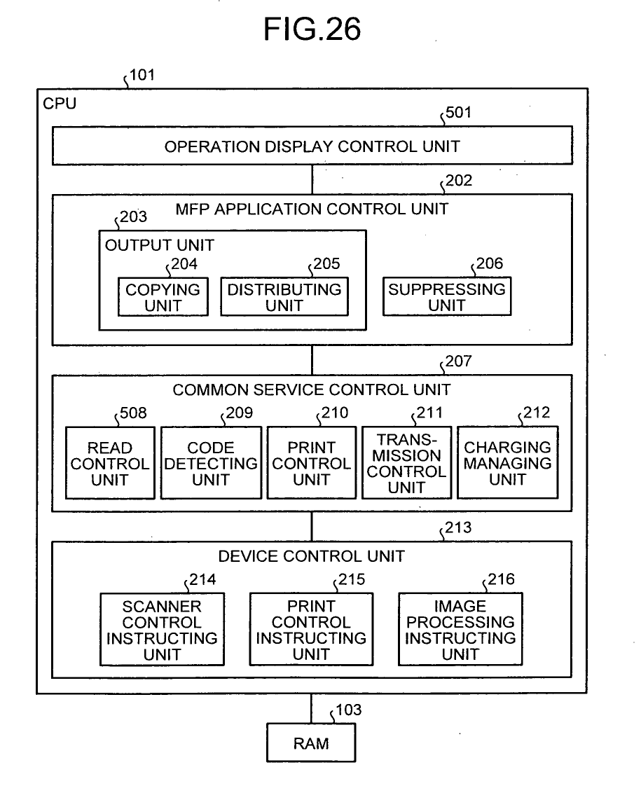

The hardware configuration of the image forming apparatus according to this embodiment is the same as that of the first embodiment. FIG. 26 is a block diagram showing the software configuration of a CPU 101 according to the fourth embodiment. As shown in FIG. 26, the CPU 101 includes an operation display control unit 501, an MFP application control unit 202, a common service control unit 207, and a device control unit 213, and is connected to the RAM 103. The functions and configurations of the individual units of the software configuration of the CPU 101 other than a read control unit 508 are the same as those of the second embodiment.

The operation display control unit 501 receives the designation of the erasure range. Specifically, the operation display control unit 501 receives the designation of a region of the document not to be read as the erasure region. Even when the designation of the erasure range is received by the operation display control unit 501, the read control unit 508 reads the whole surface of the document.

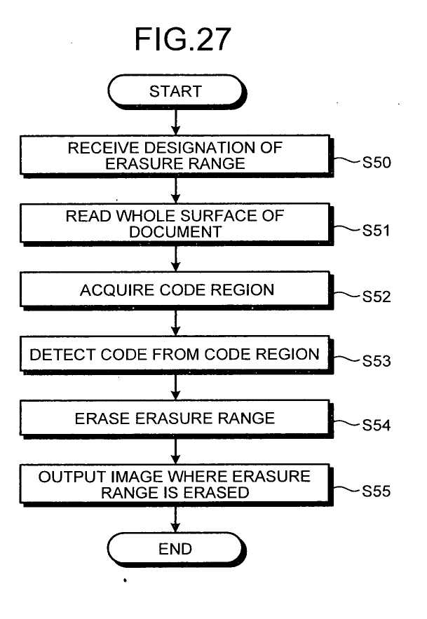

Next, a sequence of a code detecting process that is executed by the image forming apparatus according to the fourth embodiment having the above configuration will be described. FIG. 27 is a flowchart illustrating a flow of the code detecting process that is executed by the image forming apparatus according to the fourth embodiment.

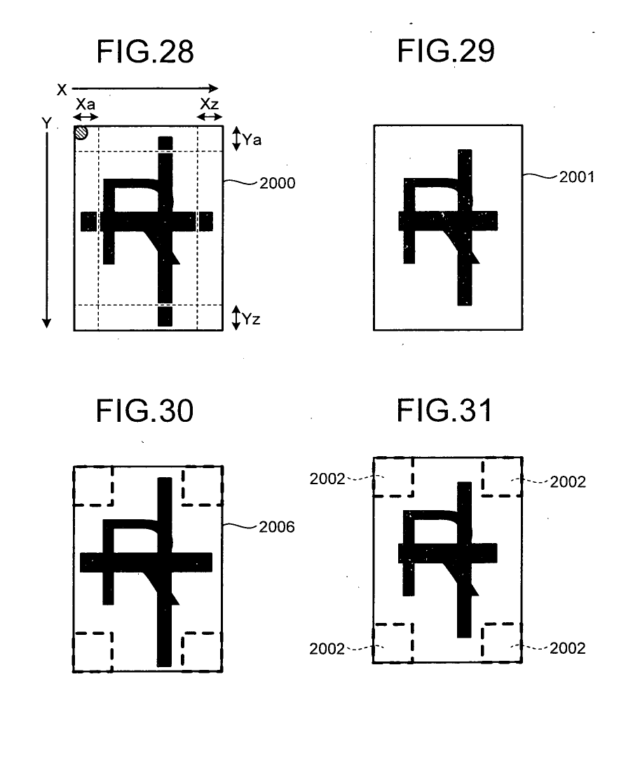

The operation display control unit 501 receives the designation of the erasure range (Step S50). In this case, the designation of the erasure range will be described. FIG. 28 shows an example of the erasure range. FIG. 28 shows a document 2000 where a frame of a predetermined range is designated as the erasure range. In FIG. 28, an arrow X shows a main scanning direction and an arrow Y shows a sub-scanning direction. A code that is shown by a shaded circle is printed on an upper left end of the document 2000. The operation display control unit 201 receives the designation of a frame of a main scanning front end shown by an arrow Xa, a frame of a main scanning rear end shown by an arrow Xz, a frame of a sub-scanning front end shown by an arrow Ya, and a frame of a sub-scanning rear end shown by an arrow Yz as the erasure range.

FIG. 29 shows an example of an image that is obtained by erasing the erasure range. As shown in FIG. 29, an image 2001 that is obtained by erasing the frames received by the operation display control unit 501 in FIG. 28 is shown. In this case, since a code of the upper left end of the document 2000 shown in FIG. 28 exists in the erasure range, the code is erased at the same time as erasing of the erasure range. Therefore, if the code detecting unit 209 detects the code of the image 2001, the code that exists in the erasure range cannot be detected.

Therefore, in Step S51, the read control unit 508 reads the whole surface of the document and acquires a document image (Step S51). FIG. 30 shows an example of the image that is read by the read control unit 508. As shown in FIG. 30, even when the erasure range is designated with respect to the document 2000 shown in FIG. 28, the read control unit 508 reads the whole surface of the document 2000 and acquires a read image 2006. The read control unit 508 acquires a code region from the RAM 103 (Step S52). FIG. 31 shows an example of the code region. As shown in FIG. 31, the read control unit 508 acquires code regions 2002 that are shown in four places of the document 2000.

The read control unit 508 passes the acquired code regions to the code detecting unit 209 and the code detecting unit 209 detects a code from the code regions (Step S53). For example, the code detecting unit 209 detects the code from the four code regions 2002.

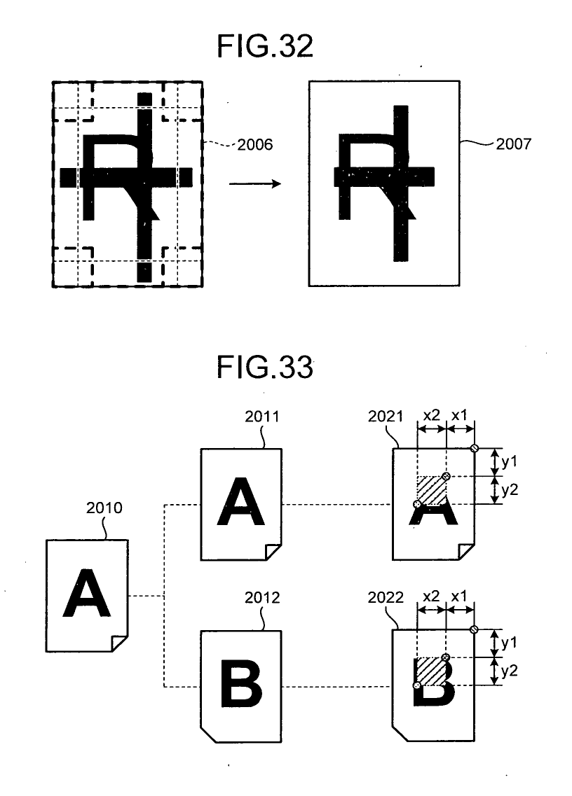

The print control unit 210 erases the erasure range, the designation of which is received by the operation display control unit 201, from the acquired document image (Step S54). FIG. 32 shows an example of an image that is acquired by erasing the erasure range. As shown in FIG. 32, the print control unit 210 has access to the image 2006 by the DMAC 114 or the CPU 101, writes white data, and acquires an image 2007. The print control unit 210 or the transmission control unit 211 outputs an image in which the erasure range is erased (Step S55). For example, the print control unit 210 prints the image 2007 and the transmission control unit 211 transmits the image 2007.

As another example, a case where the operation display control unit 201 receives the designation of an arbitrary rectangular shape in the document as the erasure range will be described. FIG. 33 shows an example of a both-sided document where an arbitrary rectangular shape in the document is designated as the erasure range. As shown in FIG. 33, the both-sided document 2010 includes a document front surface 2011 and a document back surface 2012. The read control unit 508 reads the document front surface 2011 and acquires an image 2021. The read control unit 508 reads the document back surface 2012 and acquires an image 2021. In this case, in each of the image 2021 and an image 2022, the range from an upper right end to the erasure range in the sub-scanning direction is defined as the coordinates x1 and the erasure range is defined as the coordinates x2. Further, in each of the image 2021 and the image 2022, the range from the upper right end to a rectangular erasure range 2200 in the sub-scanning direction is defined as the coordinates y1 and the erasure range is defined as the coordinates y2. As values of the coordinates x1, x2, y1, and y2 shown in FIG. 33, different values may be designated in the front surface and the back surface.

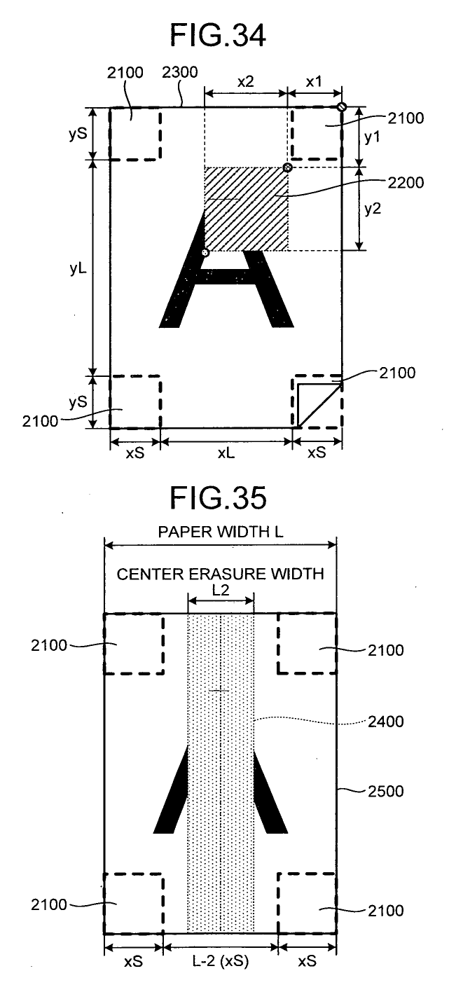

In this case, conditions where the coordinates x1, x2, y1, and y2 are overlapped to the four corners of the code regions will be described. FIG. 34 shows a positional relationship between the erasure range and the code regions. As shown in FIG. 34, code regions 2100 are positioned in four corners of a document 2300 and the rectangular erasure range 2200 is positioned in the document 2300.

In this positional relationship, the read control unit 508 determines whether the code regions 2100 are overlapped to the rectangular erasure range 2200. When it is determined that the code regions 2100 are overlapped to the rectangular erasure range 2200, the read control unit 508 passes the code region to the code detecting unit 209 before erasing the rectangular erasure range 2200 from the read image. On the other hand, when it is determined that the code regions 2100 are not overlapped to the rectangular erasure range 2200, the read control unit 508 passes the code regions to the code detecting unit 209 after erasing the rectangular erasure range 2200 from the read image.

When any one of the following conditional equations (1) to (6) is satisfied, the read control unit 508 determines that the rectangular erasure range 2200 is overlapped to a code region.

x1<xS (1)

x1>xS+xL (2)

x2>xS+xL−x1 (3)

y1<yS (4)

y1>yS+yL (5)

y2>yS+yL−y1 (6)

As another example, the case where the operation display control unit 201 receives the designation of the center of the document as the erasure range will be described: FIG. 35 shows an example of a document where the center of the document is designated as the erasure range. As shown in FIG. 35, the entire length of a document 2500 in the main scanning direction is defined as the paper width L. A value of the paper width L is a value that can be detected by the scanner engine 108 or can be designated by the user. The center erasure width is defined as the erasure width L2. The erasure width L2 that is the width of the erasure range and is designated on the basis of the center of the paper width L. The width of the code region 2100 in the main scanning direction of the document 2500 is defined as xS.

In this positional relationship, the read control unit 508 determines whether the code region 2100 is overlapped to an erasure range 2400 of the center. When it is determined that the code region 2100 is overlapped to the erasure range, the read control unit 508 passes the code region to the code detecting unit 209 before erasing the erasure range 2400 from the read image. On the other hand, when it is determined that the code region 2100 is not overlapped to the erasure range 2400, the read control unit 508 passes the code region to the code detecting unit 209 after erasing the designated erasure range from the read image.

Specifically, the read control unit 508 reads a range obtained by subtracting the erasure width L2 from the paper width L as an image without erasing the range. Therefore, when determining whether the code region 2100 is overlapped to the erasure range 2400 of the center, the read control unit 508 uses, as an overlapping determination reference, whether a range (L−2(xS)) obtained by subtracting the erasure width L2 from the paper width L is equal to or less than the double of xS of the code region. The read control unit 508 determines that the erasure range 2400 of the center is overlapped to the code region, when the following conditional equation (7) is satisfied.

L2>L−2(xS) (7)

As such, according to this embodiment, even when the erasure range is designated, the code in the code regions is detected before the erasing process is executed. Therefore, the code can be securely detected.

The code detecting program that is executed by the image forming apparatus according to this embodiment has the module configuration that includes the individual units (the read control unit, the code detecting unit, the print control unit, and the transmission control unit). As the actual hardware, the CPU (processor) reads the code detecting program from the storage medium and executes the code detecting program. As a result, the individual units are loaded on a main storage device and the read control unit, the code detecting unit, the print control unit, and the transmission control unit are generated on the main storage device.

The code detecting program that is executed by the image forming apparatus according to this embodiment may be recorded in a computer readable recording medium such a CD-ROM, a flexible disk (FD), a CD-R, and a digital versatile disk (DVD) in a form of a file having an installable format or an executable format and may be provided.

The code detecting program that is executed by the image forming apparatus according to this embodiment may be stored in a computer connected to a network such as the Internet and may be provided by downloading through the network. The code detecting program that is executed by the image forming apparatus according to this embodiment may be provided or distributed through the network such as the Internet.

The code detecting program that is executed by the image forming apparatus according to this embodiment becomes the module configuration that includes the individual units (the read control unit, the code detecting unit, the print control unit, and the transmission control unit). As the actual hardware, the CPU (processor) reads the code detecting program from the ROM and executes the code detecting program. As a result, the individual units are loaded on the main storage device and the read control unit, the code detecting unit, the print control unit, and the transmission control unit are generated on the main storage device.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An image forming apparatus, comprising:
a range designation receiving unit that receives designation of a range of an image to read;
a read control unit that performs control to read an image of a predetermined region in addition to the designated range;
a detecting unit that detects a code where information to determine a process for the range of the image is embedded, from the read image of the predetermined region; and
an image output unit that outputs the read range of the image.

2. The image forming apparatus of claim 1,
wherein the read control unit measures whether a distance from a terminating end of the predetermined region in a sub-scanning direction to the designated range is less than a predetermined threshold value, and performs the control to read an image of a region including the predetermined region and the range, when the distance is less than the threshold value.

3. The image forming apparatus of claim 1,
wherein the read control unit measures whether a distance from a terminating end of the designated range in a sub-scanning direction to the region is less than a predetermined threshold value, and performs the control to read an image of a region including the predetermined region and the range, when the distance is less than the threshold value.

4. The image forming apparatus of claim 1,
wherein the read control unit measures whether the distance from a terminating end of the predetermined region in a sub-scanning direction to the designated range is more than a predetermined threshold value, and performs control to individually read images of the predetermined region and the designated range, when the distance is more than the threshold value.

5. The image forming apparatus of claim 1,
wherein the predetermined region is at least one of four corners of a document.

6. The image formatting apparatus of claim 1,
wherein the range designation receiving unit receives the designation of the range indicating a single surface of a document, and
the read control unit performs the control to read the other surface with respect to the single surface of the document in addition to read the designated range.

7. The image forming apparatus of claim 1,
wherein the code is a code in which information to prohibit an output prohibition of an image is embedded, and
the image forming apparatus further comprises a suppressing unit that suppresses the image from being output by the image output unit when the code is detected.

8. The image forming apparatus of claim 7, further comprising:
a display control unit that causes to display, on a display unit, notification of an output prohibition of the read image,
wherein the suppressing unit instructs the display control unit to display the notification of the output prohibition, when the code is detected.

9. The image forming apparatus of claim 7, further comprising:
a mail sending unit that sends a mail notifying the output prohibition of the read image,
wherein the suppressing unit instructs the mail sending unit to send a mail of the output prohibition, when the code is detected.

10. A method of forming an image for an image forming apparatus that includes a range designation receiving unit; a read control unit; a detecting unit; and an image output unit, the method comprising:
receiving a designation of a range in an image to read by the range designation receiving unit;
controlling to read an image of a predetermined region in addition to the designated range by the read control unit;
detecting a code where information to determine processing for the image of the range is embedded, from the read image of the predetermined region by the detecting unit; and
outputting the read image of the range by the image output unit.

11. A computer program product comprising a non-transitory computer-usable medium having computer-readable program codes embodied in the medium for an image forming apparatus that includes a range designation receiving unit; a read control unit; a detecting unit; and an image output unit, the program codes when executed causing a computer to execute:
receiving a designation of a range in an image to read by the range designation receiving unit;
controlling to read an image of a predetermined region in addition to the designated range by the read control unit;
detecting a code where information to determine processing for the image of the range is embedded, from the read image of the predetermined region by the detecting unit; and
outputting the read image of the range by the image output unit.
